(19) United States
(12) Patent Application Publication
(10) Pub. No.: US 2019/0299707 A1
(43) Pub. Date: Oct. 3, 2019

(54) VEHICLE WHEEL

(71) Applicant: HONDA MOTOR CO., LTD., Tokyo (JP)

(72) Inventors: Toshinobu SAITO, Wako-shi (JP); Masaaki NISHI, Wako-shi (JP); Youichi KAMIYAMA, Wako-shi (JP)

(21) Appl. No.: 16/367,958

(22) Filed: Mar. 28, 2019

(30) Foreign Application Priority Data
Apr. 2, 2018 (JP) 2018-071164

(51) Int. Cl. B60B 21/12; B60B 21/02; B60C 19/00

(52) U.S. Cl. CPC B60B 21/12; B60B 21/026; G10K 11/172; B60B 2900/133; B60C 19/002

(57) ABSTRACT

A vehicle wheel includes a Helmholtz resonator adhered on a wheel, and a stopper supported on the wheel and configured to limit displacement of the Helmholtz resonator toward outside in a wheel radial direction. The stopper is disposed on the outside of the Helmholtz resonator in the wheel radial direction and adhered on the wheel. The stopper integral with the Helmholtz resonator forms an annular body that extends in a wheel circumferential direction on an outer circumferential surface of a well part. Moreover, a gap is formed between the Helmholtz resonator and the stopper.

### CROSS-REFERENCE TO RELATED APPLICATION

This application is based upon and claims priority from the Japanese Patent Application No. 2018-071164, filed on Apr. 2, 2018, the entire contents of which are incorporated herein by reference.

### BACKGROUND OF THE INVENTION

### 1. Field of the Invention

The present invention relates to a vehicle wheel.

### 2. Description of the Related Art

As an example of conventional art, there is known a Helmholtz resonator which is disposed on an outer circumferential surface of a well part in a wheel, and both edges of which projecting in the wheel width direction are engaged with a circumferential groove of a rim (for example, see Patent document 1: Japanese Unexamined Patent Application Publication No. 2012-45971).

The Helmholtz resonator allows the both edges thereof to be elastically deformed when pressed against the outer circumferential surface of the well part, thereby being easily fitted into the circumferential groove of the rim. Consequently, the Helmholtz resonator can be easily mounted on the wheel.

However, the conventional wheel with the Helmholtz resonator (for example, see Patent document 1) requires cutting and forming the circumferential groove for mounting the resonator on the rim. For this reason, the wheel has posed a problem in that a manufacturing process thereof becomes complicated to increase a manufacturing cost.

In order to solve the problem, for example, a resonator mounting structure is conceived in which the Helmholtz resonator is fixed to the wheel with an adhesive material.

In the Helmholtz resonator mounted on the wheel, however, an extremely large centrifugal force is generated by high-speed rotation of the tire during vehicle traveling. For this reason, a resonator mounting structure has been demanded, which is adapted to more certainly prevent the Helmholtz resonator from falling off the wheel due to the centrifugal force.

The present invention has therefore been made in view of the above problems, and an object of the invention is to provide a vehicle wheel capable of more certainly preventing a Helmholtz resonator from falling off a wheel due to a centrifugal force.

### SUMMARY OF THE INVENTION

In order to attain the above object, according to an aspect of the present invention, a vehicle wheel reflecting one aspect of the present invention includes: a Helmholtz resonator adhered on a wheel; and a stopper supported on the wheel and configured to limit displacement of the Helmholtz resonator toward outside in a wheel radial direction.

According to the vehicle wheel reflecting one aspect of the present invention, the Helmholtz resonator can be more certainly prevented from falling off the wheel due to a centrifugal force.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1 is a perspective view of a vehicle wheel according to an embodiment of the present invention.

FIG. 2 is an overall perspective view of a sub-air chamber member.

FIG. 3 is a cross-sectional view taken along the line in FIG. 1.

FIG. 4 is a partial enlarged view of the vicinity of a stopper in FIG. 1.

FIG. 5 is a partial enlarged view of the part V indicated by an arrow in FIG. 3.

FIG. 6 is a graph showing the relationship between a film thickness of an adhesive material interposed between a sub-air chamber member and a rim, and shear strength and peel strength of the adhesive material.

FIG. 7 is an explanatory view of a laser-etched surface on a vertical wall of a well part.

FIG. 8 is a partial enlarged view of the part VIII indicated by an arrow in FIG. 3.

FIG. 9 is an explanatory view of configuration of a vehicle wheel according to a first modification.

FIG. 10 is an explanatory view of configuration of a vehicle wheel according to a second modification.

FIG. 11 is an explanatory view of configuration of a vehicle wheel according to a third modification.

FIG. 12 is an explanatory view of configuration of a vehicle wheel according to a fourth modification.

### DETAILED DESCRIPTION OF THE PREFERRED EMBODIMENTS

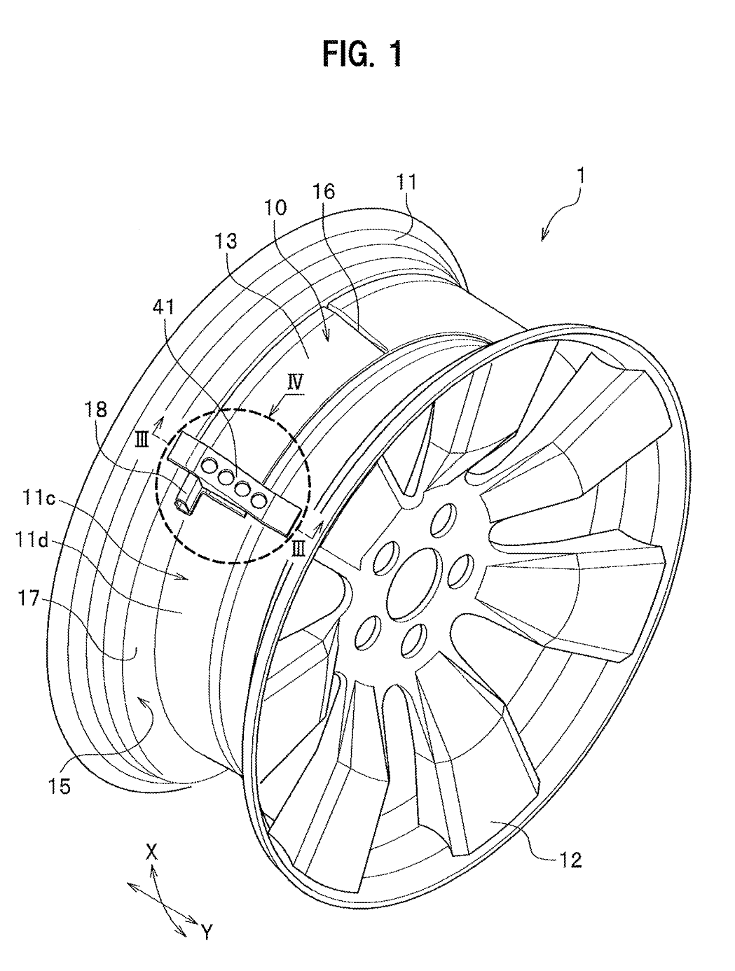

Hereinafter, vehicle wheels according to embodiments of the present invention will be described in detail with reference to the drawings as appropriate. Note that in FIG. 1 to FIG. 12 to be referred to, reference sign “X” denotes a wheel circumferential direction; reference sign “Y” denotes a wheel width direction; and reference sign “Z” denotes a wheel radial direction. Moreover, in the wheel width direction Y, an inner side is defined as “one side” and an outer side is defined as “other side”.

In the description below, overall structure of a vehicle wheel will be first described, and then description will be given of a sub-air chamber member serving as a Helmholtz resonator and of a mounting structure of the sub-air chamber member on a rim by an adhesive material.

### <Overall Structure of Vehicle Wheel>

FIG. 1 is a perspective view of a vehicle wheel 1 according to an embodiment of the present invention.

As shown in FIG. 1, the vehicle wheel 1 according to the present embodiment is configured to allow a sub-air chamber member 10 (Helmholtz resonator) made of a synthetic resin such as polyamide resin to be mounted on a rim 11 made of metal such as aluminum alloy and magnesium alloy.

Moreover, the vehicle wheel 1 is provided with a stopper 41 as described in detail later.

In FIG. 1, reference sign 12 denotes a disk 12 for connecting the rim 11 to a hub (not shown).

The rim 11 includes a well part 11c which is concave inward (toward a rotation center) in the wheel radial direction between bead seats (not shown) formed on both end parts of the rim 11 in the wheel width direction Y. An outer circumferential surface 11d of the well part 11c is defined by a bottom face of the concave part and has substantially the same diameter on the wheel shaft throughout the wheel width direction Y.

The rim 11 in the present embodiment is provided with a vertical wall 15.

Incidentally, the vertical wall 15 in the present embodiment is formed at the one side (inner side) in the wheel width direction Y and in a rising part 17 that erects from the outer circumferential surface 11d of the well part 11c toward a rim flange side.

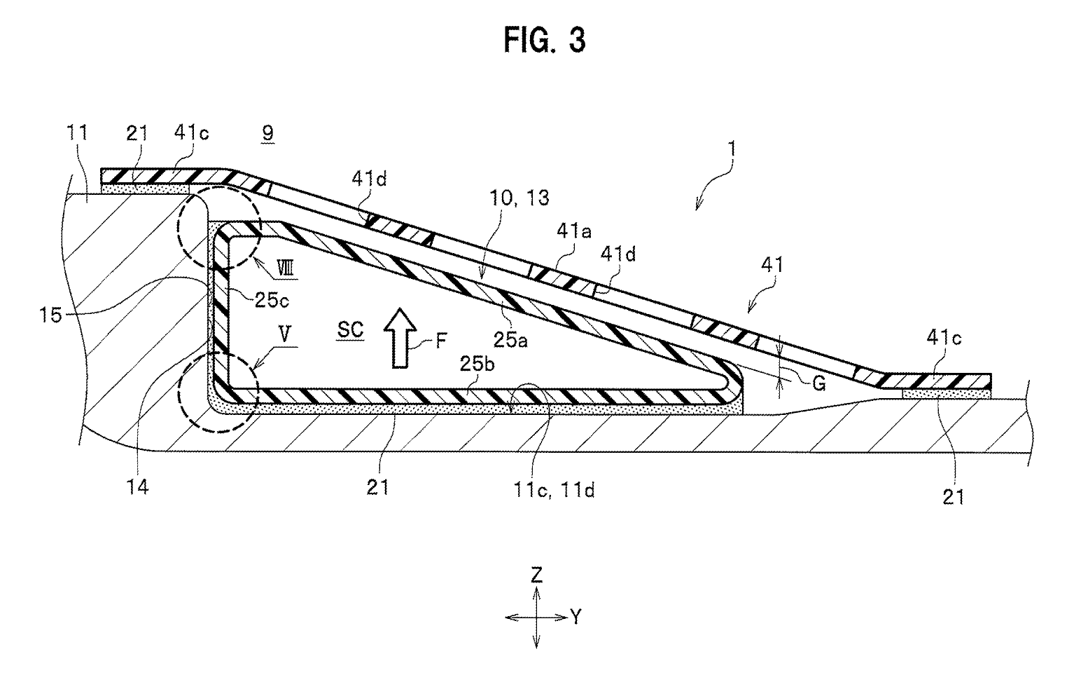

Although the vertical wall 15 annularly extends in the wheel circumferential direction X to forma side face 14 such that an angle between the side face 14 and the outer circumferential surface 11d (see FIG. 3) is substantially a right angle, a side face may be formed so that an angle between the side face and the outer circumferential surface 11d is an angle exceeding 90 degrees as described later.

### <Sub-Air Chamber Member>

Next, the sub-air chamber member 10 will be described.

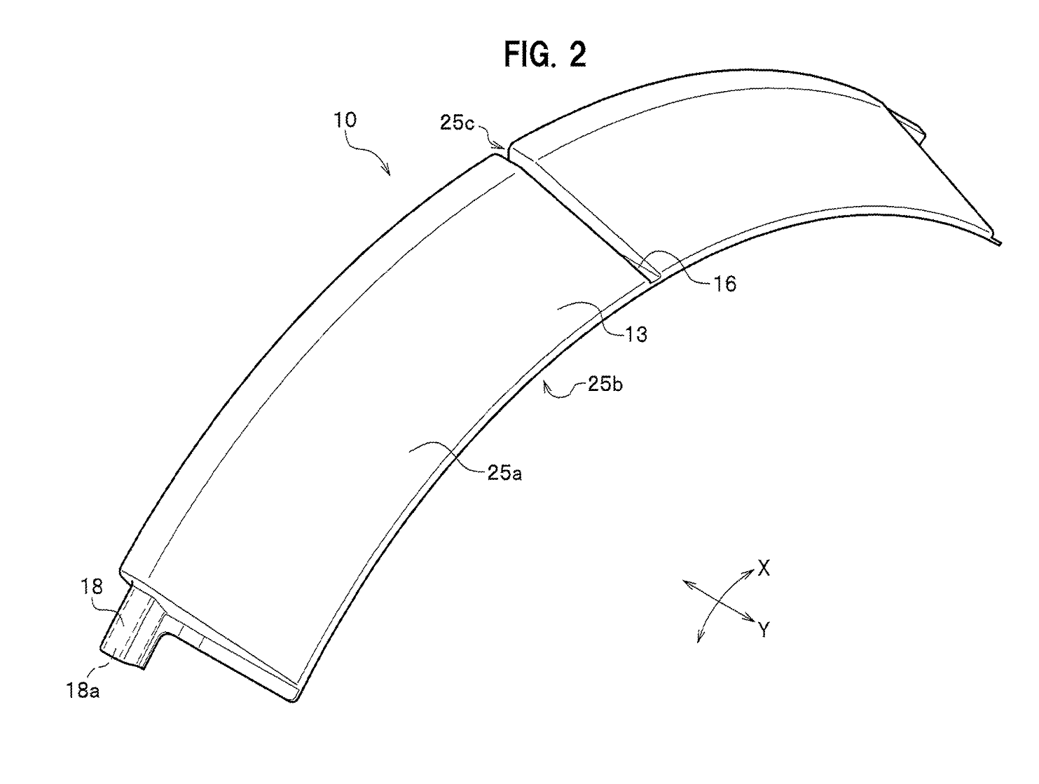

FIG. 2 is an overall perspective view of the sub-air chamber member 10. FIG. 3 is a cross-sectional view taken along the III-III line in FIG. 1.

As shown in FIG. 2, the sub-air chamber member 10 is a member elongated in the wheel circumferential direction X and includes a main body 13 and a tubular body 18. The sub-air chamber member 10 is configured to have a symmetric shape in the wheel circumferential direction X with respect to a partition wall 16 that extends in the wheel width direction Y at the center of the main body 13.

The main body 13 is curved in a longitudinal direction thereof. In other words, the main body 13 is configured to follow the wheel circumferential direction X when the sub-air chamber member 10 is mounted on the outer circumferential surface 11d (see FIG. 1) of the well part 11c (see FIG. 1).

The main body 13 has a hollow part inside. The hollow part (not shown) forms a sub-air chamber SC (see FIG. 3) as described later. The hollow part is divided by the partition wall 16 into two parts in the wheel circumferential direction X.

As shown in FIG. 3, the main body 13 has the form of a right triangle in cross section orthogonal to the longitudinal direction (the wheel circumferential direction X in FIG. 2).

More specifically, the main body 13 has configuration in which a bottom part 25b (bottom plate) that is disposed along the outer circumferential surface 11d of the well part 11c, a side part 25c (side plate) that is disposed along the side face 14 of the vertical wall 15, and an upper part 25a (upper plate) that forms a hypotenuse between the bottom part 25b and the side part 25c, are mutually connected so as to form a right triangle.

That is, the side part 25c and the bottom part 25b forma right angle by the angle of inclusion between them. The upper part 25a extends to form an ascending slope from the bottom part 25b side toward the side part 25c.

Moreover, between the outer circumferential surface 11d of the well part 11c and the bottom part 25b, and between the side face 14 of the vertical wall 15 and the side part 25c, clearances of predetermined gaps are formed so that an adhesive material 21 having film thicknesses as described later can be interposed.

Thus, the upper part 25a, the bottom part 25b and the side part 25c are formed to surround the sub-air chamber SC inside the main body 13.

Next, the tubular body 18 (see FIG. 1) will be described. As shown in FIG. 1, the tubular body 18 is formed at a position biased to the one side (the inner side of the vehicle wheel 1) in the wheel width direction Y on the main body 13 so as to protrude from the main body 13 in the wheel circumferential direction X.

The sub-air chamber member 10 in the present embodiment is formed, as described above, into a symmetric shape in the wheel circumferential direction X with respect to the partition wall 16. Accordingly, although only one tubular body 18 is shown in FIG. 1, the tubular bodies 18 in the present embodiment are disposed to form a pair at positions symmetrical to each other on both end parts in the longitudinal direction (the wheel circumferential direction X) of the main body 13.

As shown in FIG. 2, the tubular body 18 has a communication hole 18a formed inside.

The communication hole 18a allows the sub-air chamber SC (see FIG. 3) formed inside the main body 13 to be communicated with a tire air chamber 9 (see FIG. 3) which is to be formed between the well part 11c (see FIG. 3) and a tire (not shown).

The sub-air chamber member 10 in the present embodiment is a blow molded product using a synthetic resin such as polyamide resin as described above. Note that the above synthetic resin is not specifically limited, but polyamide resin containing polyamide MXD6 (Registered trade mark) as a base resin, and nylon 6 are especially preferably used.

### <Stopper>

Next, the stopper 41 (see FIG. 1) will be described.

The stopper 41 in the present embodiment is composed of a bent plate-like body consisting of resin, metal, or resin-fiber composite material (e.g., carbon-fiber reinforced plastic (CFRP)).

As shown in FIG. 1, the stopper 41 is disposed on one end part in the wheel circumferential direction X of the main body 13 composing the sub-air chamber member 10.

Note that, although only one stopper 41 is shown in FIG. 1 for convenience of illustration, another stopper is disposed on the other end part (not shown) on the opposite side of the main body 13 which is symmetrical to the one end part with respect to the partition wall 16.

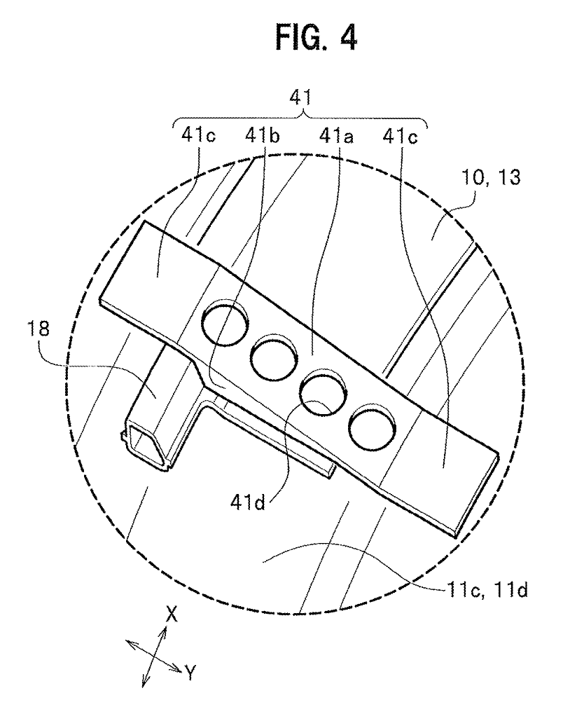

FIG. 4 is a partial enlarged view of the vicinity of the stopper 41 in FIG. 1.

As shown in FIG. 4, the stopper 41 is composed of a stopper main body 41a, a folded section 41b, and supporting parts 41c.

The stopper main body 41a has a plurality of through-holes 41d (four through-holes in the present embodiment) and is formed of a plate-like body elongated in the wheel width direction Y. The through-holes 41d make it possible to achieve weight saving of the stopper 41.

As shown in FIG. 3, the stopper main body 41a is disposed on the outer side in the wheel radial direction Z of the sub-air chamber member 10 (Helmholtz resonator) so as to stride over the sub-air chamber member 10 in the wheel width direction Y.

More specifically, the stopper main body 41a is inclined with a gap G so as to be nearly parallel to the upper part 25a (upper plate) composing the main body 13 of the sub-air chamber member 10.

As shown in FIG. 4, the folded section 41b is formed of a plate-like body of a nearly triangular shape in side view that bends and extends from edges in the wheel circumferential direction X of the stopper main body 41a toward the outer circumferential surface 11d of the well part 11c. The folded section 41b is disposed so as to cover an end face in the wheel circumferential direction X of the main body 13.

The folded section 41b allows displacement in the circumferential direction of the sub-air chamber member 10 (Helmholtz resonator) to be restricted.

As shown in FIG. 4, the supporting part 41c is composed of a plate-like body that is connected to both ends in the wheel width direction Y of the stopper main body 41a, respectively.

### <Mounting Structure of Sub-Air Chamber Member>

Next, description will be given of a mounting structure of the sub-air chamber member 10 (see FIG. 1) on the rim 11 (see FIG. 1).

As shown in FIG. 3, the main body 13 of the sub-air chamber member 10 allows the bottom part 25b and the outer circumferential surface 11d of the well part 11c to be connected via the adhesive material 21, and allows the side part 25c and the side face 14 of the vertical wall 15 to be connected via the adhesive material 21.

Examples of the adhesive material 21 include thermoplastic resin-based adhesive such as ethylene-vinyl acetate resin; thermosetting resin-based adhesive such as epoxy resin, polyurethane resin, acrylic resin and polyamide resin; and elastomer-based adhesive such as synthetic rubber and thermoplastic elastomer, but the adhesive material is not limited to these examples.

Incidentally, the form of hardening of the adhesive material 21 is not specifically limited, but chemical reaction hardening is especially preferably used.

The adhesive material 21 can be coated on either the sub-air chamber member 10 or the rim 11. Moreover, the adhesive material 21 can also be coated on both of the sub-air chamber member 10 and the rim 11.

Examples of coating method for the adhesive material 21 include bar coating method, roll coating method, spray coating method, brush coating method, and hot-melt coating method, but the coating method is not limited to these examples.

Next, film thicknesses of the adhesive material 21 will be described.

As shown in FIG. 3, the adhesive material 21 applied to the space between the sub-air chamber member 10 and the rim 11 forms a continuous film that ranges from the outer circumferential surface 11d of the well part 11c to the side face 14 of the vertical wall 15. This film fills all of the clearances described above which are formed between the main body 13 and the well part 11c.

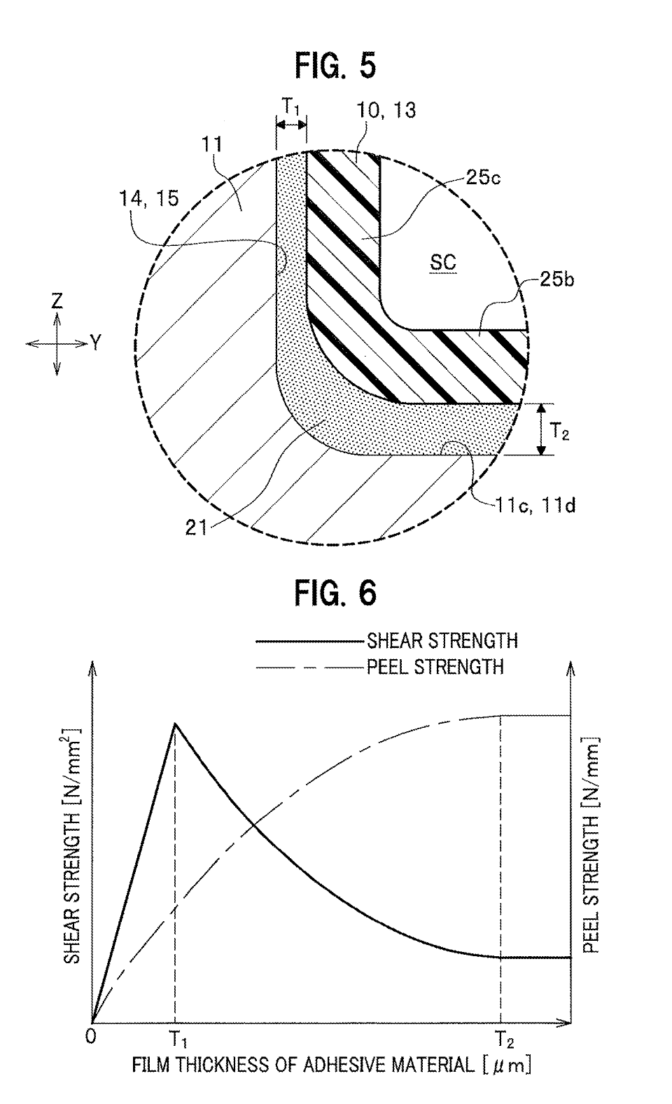

FIG. 5 is a partial enlarged view of the part V indicated by an arrow in FIG. 3. In FIG. 5, the same constituent element as in FIG. 3 is given the same reference sign and thus detailed explanation thereof is omitted.

As shown in FIG. 5, a film thickness T₁ of the adhesive material 21 on the side face 14 of the vertical wall 15 is set to be thinner than a film thickness T₂ of the adhesive material 21 on the outer circumferential surface 11d of the well part 11c.

Controlling the film thicknesses T₁, T₂ of the adhesive material 21 in this way allows fixing strength of the sub-air chamber member 10 to the rim 11 to be extremely enhanced.

This will be described below. A centrifugal force F (see FIG. 3) generated in the sub-air chamber member 10 during high-speed rotation of the tire (not shown) acts on the adhesive material 21 on the side face 14 in a shearing direction and acts on the adhesive material 21 on the outer circumferential surface 11d in a peeling direction.

In contrast, the adhesive material 21 has higher shear strength as it becomes thinner and has higher peel strength as it becomes thicker.

On the other hand, in the vehicle wheel 1 according to the present embodiment as shown in FIG. 3, the upper part 25a (upper plate) of the main body 13 is inclined to form a descending slope at greater distances from the vertical wall 15. That is, mass m of materials forming the upper part 25a, in other words, distance r from the rotation center of the mass m being a constituent element of the centrifugal force (mrω², where ω is a turning angle velocity) becomes shorter at greater distances from the vertical wall 15. As a result, the centrifugal force acting on the main body 13 becomes smaller at greater distances from the vertical wall 15.

On the contrary, the centrifugal force acts most largely on apart of the main body 13 adjacent to the vertical wall 15, to which mass of materials forming the side part 25c (side plate) is added.

The part of the main body 13 adjacent to the vertical wall 15, on which the centrifugal force acts most largely, satisfies the relation of “film thickness T₁<film thickness T₂”, thus allowing both “shear strength” of the adhesive material 21 on the side face 14 and “peel strength” of the adhesive material 21 on the outer circumferential surface 11d to be enhanced. This allows the fixing strength of the sub-air chamber member 10 to the rim 11 to be extremely enhanced.

Moreover, more preferable setting of film thicknesses of the adhesive material 21 satisfying the relation of “film thickness T₁<film thickness T₂” is as follows. FIG. 6 is a graph showing the relationship between the film thickness [μm] of the adhesive material 21 interposed between the sub-air chamber member 10 and the rim 11 shown in FIG. 3, and the shear strength [N/mm²] and the peel strength [N/mm] of the adhesive material 21. Note that the shear strength [N/mm²] is measured on the basis of JIS K6850 (1999), and the peel strength [N/mm] is measured on the basis of JIS K6854 (1999).

As shown in FIG. 6, the shear strength [N/mm²] increases, then reaches a predetermined yield point (see the film thickness T₁) and then decreases as the film thickness of the adhesive material 21 (see FIG. 3) becomes increased from 0 [μm]. That is, the shear strength [N/mm²] becomes the maximum at the yield point (see the film thickness T₁).

Moreover, the peel strength [N/mm] gradually increases and then reaches a saturation point (see the film thickness T₂) as the film thickness becomes increased from 0 [μm]. That is, the peel strength [N/mm] becomes the maximum at the saturation point (see the film thickness T₂).

Accordingly, the sub-air chamber member 10 (see FIG. 3) in the present embodiment allows the film thickness of the adhesive material 21 (see FIG. 3) on the vertical wall 15 (see FIG. 3) to be set to T₁ shown in FIG. 6, and the film thickness of the adhesive material 21 on the outer circumferential surface 11d (see FIG. 3) to be set to T₂ shown in FIG. 6, thereby allowing the fixing strength of the sub-air chamber member 10 to the rim 11 to become the maximum.

Incidentally, the relation of the shear strength [N/mm²], the peel strength [N/mm], and the film thickness [μm] of the adhesive material 21 shown in FIG. 6 can be calculated by CAE (Computer Aided Engineering) analysis executed in advance according to materials of the rim 11 and the kind of the adhesive material 21 to be used.

Moreover, the applied surface of the adhesive material 21 (see FIG. 3) in the mounting structure of the sub-air chamber member 10 (see FIG. 3) is preferably roughened. It is more preferable that the applied surface is formed of a laser-etched surface above all.

In particular, it is still more preferable that the applied surface of the adhesive material 21 in which a shearing force is generated during action of the centrifugal force F (see FIG. 3) is formed of a laser-etched surface. In other words, it is still more preferable that the side face 14 of the vertical wall 15 shown in FIG. 3, and/or the side part 25c of the main body 13 are each formed of a laser-etched surface.

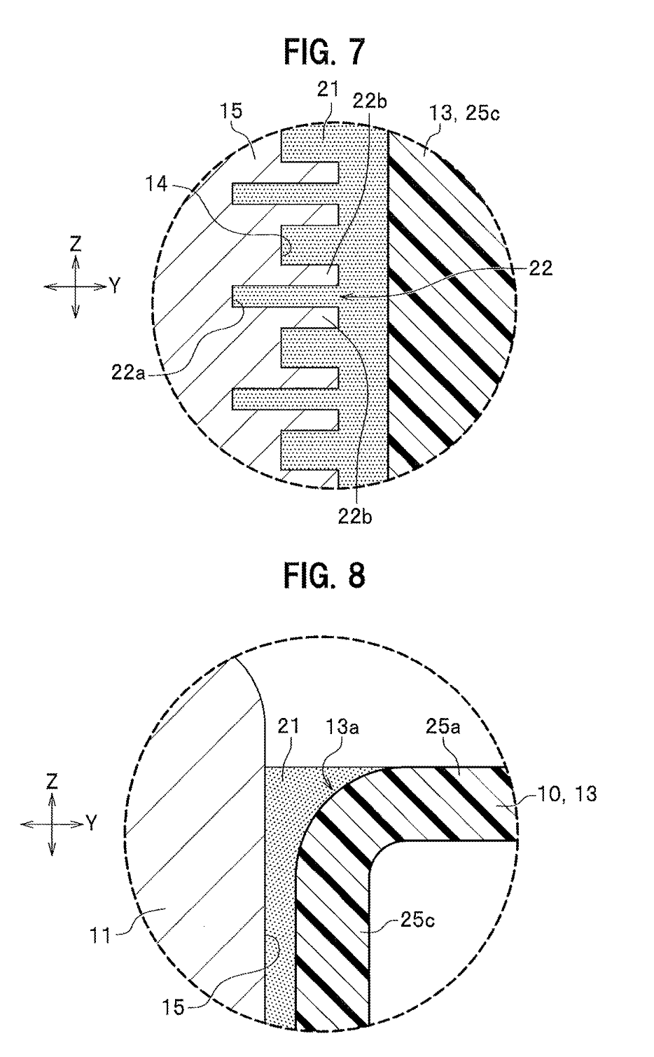

FIG. 7 is an explanatory view of a laser-etched surface 22 on the vertical wall 15. In FIG. 7, reference sign 25c denotes a side part (side plate) of the main body 13, and reference sign 21 denotes an adhesive material.

As shown in FIG. 7, the side face 14 of the vertical wall 15 is formed of the laser-etched surface 22.

The laser-etched surface 22 is composed of an etched groove 22a and a ridge part 22b.

The laser-etched surface 22 in the present embodiment is formed on the side face 14, e.g., when a YAG laser is scanned in one direction on the side face 14, and extends with a predetermined groove depth from the front side of the page space in FIG. 7 toward the back side of the page space.

Moreover, the ridge part 22b in the present embodiment is formed with protrusion of a predetermined height at both sides in a width direction of the etched groove 22a, respectively, and extends in an extending direction of the etched groove 22a.

The laser-etched surface 22 is formed, e.g., by allowing a YAG laser to be scanned with a predetermined width of hatching on the side face 14. More specifically, the YAG laser causes the etched groove 22a to be formed with a predetermined depth and substance eluted by laser irradiation deposits and hardens at both sides of the etched groove 22a, thereby allowing the ridge part 22b to be formed with a predetermined height.

Note that, although the extending direction of the etched groove 22a and the ridge part 22b in the present embodiment is set to the wheel circumferential direction X, it is not limited to the wheel circumferential direction X.

The present embodiment allows the laser-etched surface 22 to be set on the side face 14, thereby allowing the adhesive material 21 to be filled in the etched groove 22a and between adjacent ridge parts 22b. Moreover, on the laser-etched surface 22 although not shown, an end part of the ridge part 22b is displaced in a groove width direction of the etched groove 22a to allow a side face of the ridge part 22b to overhang, or the end parts of the adjacent ridge parts 22b are connected to each other on the etched groove 22a to partially form an arch.

This allows anchor structure of the adhesive material 21 to be constructed on the laser-etched surface 22 by the adhesive material 21 deeply entering the etched groove 22a and the adhesive material 21 engaged with the overhanging portion and the arch.

Accordingly, the fixing strength of the sub-air chamber member 10 to the rim 11 becomes enhanced.

Moreover, the laser-etched surface 22 makes it possible to further improve the fixing strength of the sub-air chamber member 10 to the rim 11 through enhancing effects of wettability accompanied by surface free energy structure of solid parts of metal (see Young's equation of angle of contact).

Note that it goes without saying that the laser-etched surface 22 can also be formed on the side part 25c of the main body 13 as described above.

FIG. 8 is a partial enlarged view of the part VIII indicated by an arrow in FIG. 3.

As shown in FIG. 8, a corner radius section 13a is formed at a junction of the upper part 25a and the side part 25c of the main body 13.

The adhesive material 21 located between the vertical wall 15 and the side part 25c allows an upper part thereof to spread above the corner radius section 13a to cover the corner radius section 13a from above.

The adhesive material 21 covering the corner radius section 13a from above makes it possible to further enhance the fixing strength of the sub-air chamber member 10 to the rim 11.

### <Mounting Structure of Stopper>

Next, description will be given of a mounting structure of the stopper 41 (see FIG. 1) on the rim 11 (see FIG. 1).

As shown in FIG. 3, the stopper 41 allows the stopper main body 41a to be disposed on the outer side in the wheel radial direction Z of the sub-air chamber member 10 so as to stride over the sub-air chamber member 10 in the wheel width direction Y.

Of a pair of supporting parts 41c, one supporting part 41c is connected via the adhesive material 21 to a flat surface of the rim 11, which is adjacent to an upper end of the vertical wall 15 and extends from the upper end of the vertical wall 15 toward the rim flange side.

Moreover, the other supporting part 41c is connected via the adhesive material 21 to the outer circumferential surface 11d of the well part 11c.

As for the adhesive material 21, the same adhesive material as that used in the above adhesion of the sub-air chamber member 10 to the rim 11 can be used. The adhesive material 21 can be coated on either the stopper 41 or the rim 11. Moreover, the adhesive material 21 can also be coated on both of the stopper 41 and the rim 11.

Examples of coating method for the adhesive material 21 include bar coating method, roll coating method, spray coating method, brush coating method, and hot-melt coating method, but the coating method is not limited to these examples.

Shear adhesion (adhesive strength) of the stopper 41 to the rim 11 can be defined by a ratio of mass of the stopper 41 to an adhesive area of the stopper 41 to the rim 11. Moreover, from the point of view of design standard for safety, setting of the ratio of the mass of the stopper 41 to the adhesive area is carried out so as to allow the sub-air chamber member 10 to certainly fall off the rim 11 at a lower rotational speed than a rotational speed at which the stopper 41 falls off the rim 11. Compared with the ratio of a total of set adhesive strength (the shear strength and the peel strength) to unit mass of the sub-air chamber member 10, the corresponding ratio in the stopper 41 is set sufficiently high.

The stopper 41 is adapted to limit displacement of the sub-air chamber member 10 (Helmholtz resonator) toward outside in the wheel radial direction Z and in the wheel circumferential direction X, as described below.

### Operation and Effects

Next, description will be given of operation and effects of the vehicle wheel 1 according to the present embodiment.

The vehicle wheel 1 according to the present embodiment allows the sub-air chamber member 10 to be mounted on the rim 11 with the adhesive material 21.

The vehicle wheel 1 thus configured differs from the conventional vehicle wheel (for example, see Patent document 1) and has no need to cut and form a circumferential groove for mounting the sub-air chamber member 10 on the rim 11. Accordingly, the vehicle wheel 1 makes it possible to simplify a manufacturing process to reduce a manufacturing cost as compared to the conventional art.

Moreover, the stopper 41 in the vehicle wheel 1 according to the present embodiment is disposed on the outside of the sub-air chamber member 10 in the wheel radial direction Z to be adhered on the wheel (the rim 11) separately from the sub-air chamber member 10.

The vehicle wheel 1 thus configured allows a centrifugal force generated in the sub-air chamber member 10 per se to be not applied directly to the stopper 41. Accordingly, the sub-air chamber member 10 together with the stopper 41 is prevented from falling off the rim 11 toward an inner circumferential wall side of the tire (not shown). That is, even if the adhesive layer (adhesive material 21) between the sub-air chamber member 10 and the outer circumferential surface 11d of the well part 11c is broken during rotation of the wheel, the sub-air chamber member 10 is caught by the stopper 41 to allow displacement thereof toward outside in the wheel radial direction Z and in the wheel circumferential direction X to be limited. The sub-air chamber member 10 caught by the stopper 41 is held in the well part 11c.

Moreover, in the vehicle wheel 1, the gap G is formed between the sub-air chamber member 10 and the stopper 41.

When the adhesive layer (adhesive material 21) between the sub-air chamber member 10 and the outer circumferential surface 11d of the well part 11c is broken, the vehicle wheel 1 configured as described above allows the sub-air chamber member 10 displaced in the centrifugal direction to come into contact with the stopper 41, thereby generating an abnormal noise.

This makes it possible for a user to perceive from the abnormal noise that the sub-air chamber member 10 is caught by the stopper 41 to be held. That is, the user can recognize the abnormal noise as predictable phenomenon until the sub-air chamber member 10 completely falls off the rim 11 toward the inner circumferential wall side of the tire (not shown). Therefore, the user can prepare for repair and restoration of the sub-air chamber member 10 through predictability of the vehicle wheel 1.

Although the embodiment of the present invention has been described above, the present invention is not limited to the above embodiment and can be put into practice in various forms.

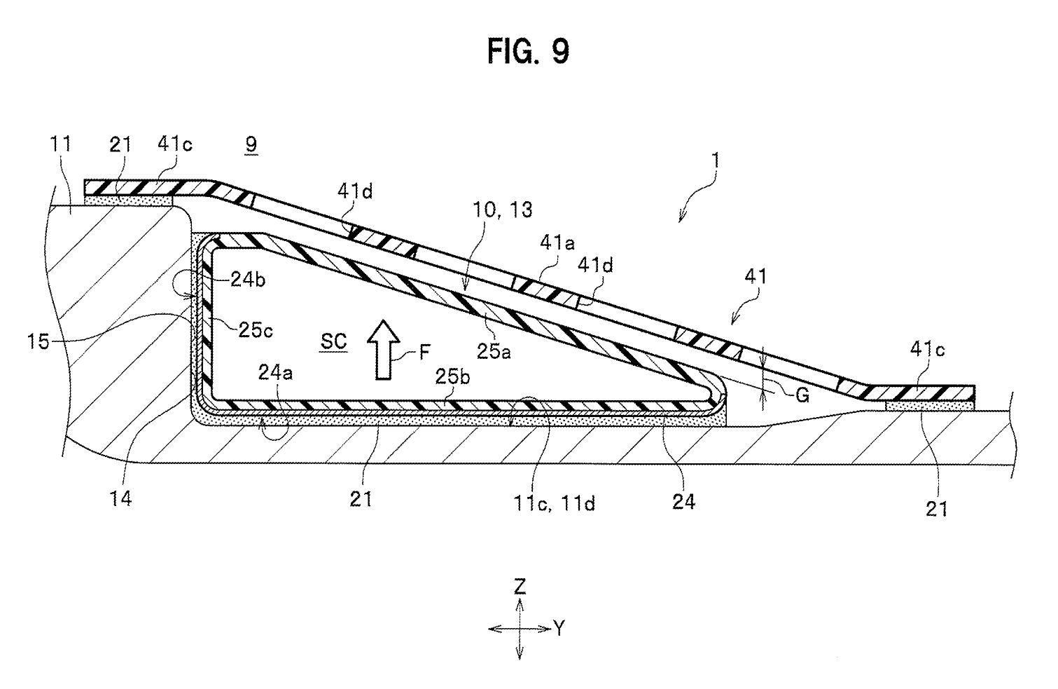

FIG. 9 is a local sectional view of the sub-air chamber member 10 according to a first modification, which is composed of two kinds of materials, and is a sectional view corresponding to FIG. 3. Note that in FIG. 9, the same constituent element as in FIG. 3 is given the same reference sign and thus detailed explanation thereof is omitted.

As shown in FIG. 9, the main body 13 of the sub-air chamber member 10 has a metal plate 24 serving as a smoothing member for adhesion, on opposed surfaces 24a, 24b that are opposed to the outer circumferential surface 11d of the well part 11c and the side face 14 of the vertical wall 15.

The metal plate 24 (the smoothing member for adhesion) is formed of the same material as that of the rim 11, but the material is not limited to this example.

The metal plate 24 allows the opposed surface 24a opposed to the outer circumferential surface 11d to have a flat surface for adhesion of the adhesive material 21. As for the flat surface, the surface of the metal plate 24 is treated, e.g., by electrolytic polishing or buffing, so as to have the degree of flatness of 1 μm or less.

Moreover, the opposed surface 24b of the metal plate 24 opposed to the side face 14 is obtained by performing flattening treatment described above, followed by performing laser-etching (see the laser-etched surface 22 in FIG. 7).

The sub-air chamber member 10 thus configured can be obtained by insert molding in which the metal plate 24 is arranged in a metal mold beforehand.

The vehicle wheel 1 (see FIG. 1) having the sub-air chamber member 10 configured as shown in FIG. 9 allows the opposed surfaces 24a, 24b of the sub-air chamber member 10 to the rim 11 to have a flat surface, thus facilitating control of film thicknesses of the adhesive material 21. This makes it possible for the vehicle wheel 1 to more securely enhance the fixing strength of the sub-air chamber member 10 to the rim 11.

Moreover, the vehicle wheel 1 makes it possible to further enhance rigidity of the main body 13 of the sub-air chamber member 10, through reinforcing effect by the metal plate 24.

Furthermore, the vehicle wheel 1 allows the opposed surface 24b of the metal plate 24 opposed to the side face 14 to be formed of the laser-etched surface 22, thus allowing the fixing strength of the sub-air chamber member 10 to the rim 11 to be further increased.

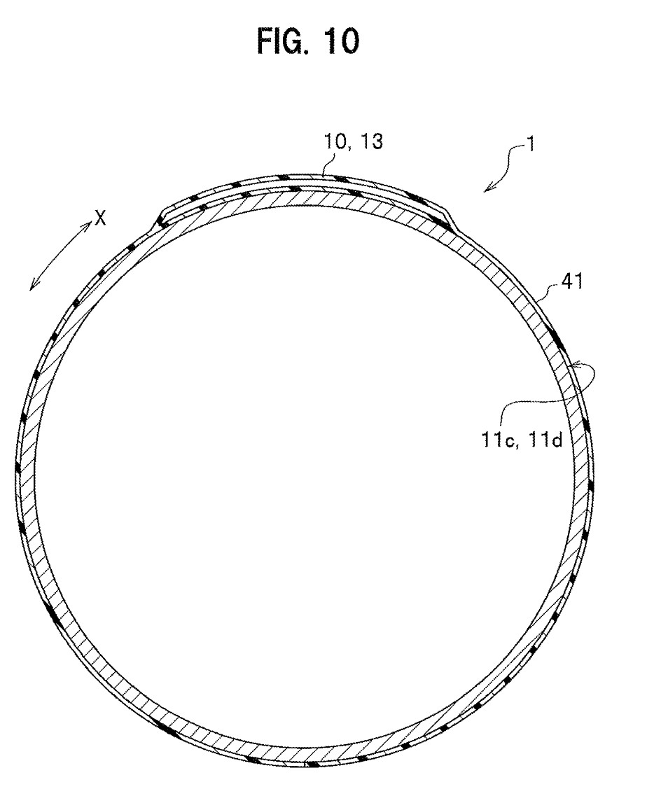

FIG. 10 is an explanatory view of configuration of the vehicle wheel 1 according to a second modification.

As shown in FIG. 10, the vehicle wheel 1 according to the second modification allows the main body 13 of the sub-air chamber member 10 to be formed integral with the stopper 41.

The stopper 41 forms an annular body that extends in the wheel circumferential direction X on the outer circumferential surface 11d of the well part 11c.

Moreover, the main body 13 is adhered on the outer circumferential surface 11d of the well part 11c with an adhesive material (not shown).

Note that, although the second modification assumes that the stopper 41 is in contact with, but not adhered on, the outer circumferential surface 11d of the well part 11c, the present invention may adopt configuration such that the stopper 41 is adhered on the outer circumferential surface 11d.

According to the vehicle wheel 1 thus configured, even if an adhesive layer (not shown) between the sub-air chamber member 10 and the outer circumferential surface 11d of the well part 11c is broken during rotation of the wheel, displacement of the sub-air chamber member 10 toward outside in the wheel radial direction Z and in the wheel circumferential direction X is limited by the stopper 41. The sub-air chamber member 10 is held by the stopper 41 in the well part 11c.

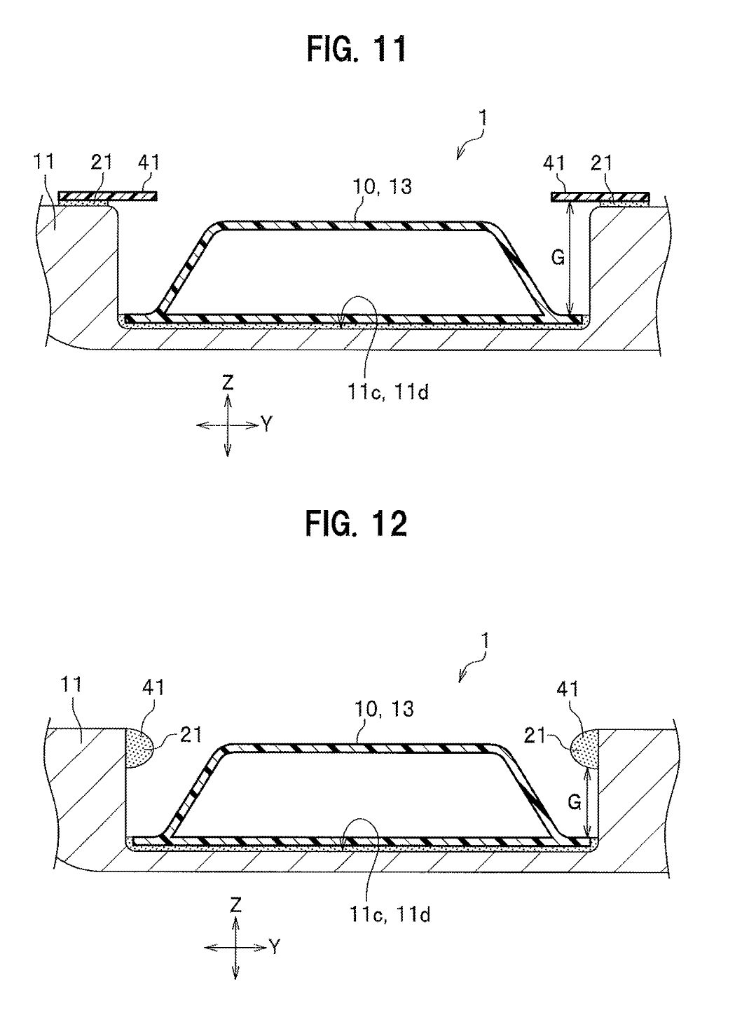

FIG. 11 is an explanatory view of configuration of the vehicle wheel 1 according to a third modification.

As shown in FIG. 11, the vehicle wheel 1 according to the third modification allows a bottom part of the sub-air chamber member 10 to be connected via the adhesive material 21 to substantially the entire width of the outer circumferential surface 11d of the well part 11c in the wheel width direction Y.

Moreover, above both edges in the wheel width direction Y of the sub-air chamber member 10 (on the outer side in the wheel radial direction Z), the stoppers 41, 41 are disposed each protruding in the form of an eave from the rim 11 located at the outer side in the wheel width direction Y of the well part 11c. That is, the gap G is formed between the sub-air chamber member 10 and the stopper 41.

The stopper 41 assumes configuration such that a plate-like body extending in the wheel circumferential direction X (see FIG. 1) is joined via the adhesive material 21 to the rim 11.

According to the vehicle wheel 1 thus configured, even if the adhesive layer (adhesive material 21) between the sub-air chamber member 10 and the outer circumferential surface 11d of the well part 11c is broken during rotation of the wheel, displacement of the sub-air chamber member 10 toward outside in the wheel radial direction Z and in the wheel circumferential direction X is limited by the stopper 41. The sub-air chamber member 10 is held by the stopper 41.

Moreover, when the adhesive material 21 is broken, the vehicle wheel 1 allows the sub-air chamber member 10 displaced in the centrifugal direction to come into contact with the stopper 41, thereby generating an abnormal noise.

This makes it possible for the user to recognize the abnormal noise as predictable phenomenon until the sub-air chamber member 10 completely falls off the rim 11 toward the inner circumferential wall side of the tire (not shown).

FIG. 12 is an explanatory view of configuration of the vehicle wheel 1 according to a fourth modification.

As shown in FIG. 12, the vehicle wheel 1 according to the fourth modification has a stopper 41 composed of a projection formed of hardened material of the adhesive material 21, in place of the plate-like stopper 41 in the vehicle wheel 1 (see FIG. 11) according to the third modification.

According to the vehicle wheel 1 according to the fourth modification, the same operation and effects as those in the vehicle wheel 1 according to the third modification can be produced, and formation of the stopper 41 can be simplified.

Moreover, although the embodiment and modifications described above assumes that the angle between the well part 11c and the vertical wall 15 is set to 90 degrees, the angle can also be set to an angle exceeding 90 degrees.

Although embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS

1: Vehicle wheel; 10: Sub-air chamber member; 11: Rim; 11c: Well part; 11d: Outer circumferential surface; 13: Main body; 13a: Corner radius section; 14: Side face; 15: Vertical wall; 18: Tubular body; 18a: Communication hole; 21: Adhesive material; 22: Laser-etched surface; 22a: Etched groove; 22b: Ridge part; 24: Metal plate; 25a: Upper part; 25b: Bottom part; 25c: Side part; 41: Stopper; 41a: Stopper main body; 41b: Folded section; 41c: Supporting part; 41d: Through-hole; F: Centrifugal force; G: Gap; SC: Sub-air chamber; T1: Thickness of adhesive material; T2: Thickness of adhesive material; X: Wheel circumferential direction; Y: Wheel width direction; Z: Wheel radial direction

What is claimed is:

1. A vehicle wheel comprising:
a Helmholtz resonator adhered on a wheel; and
a stopper supported on the wheel and configured to limit displacement of the Helmholtz resonator toward outside in a wheel radial direction.

2. The vehicle wheel according to claim 1, wherein
the stopper is disposed on the outside of the Helmholtz resonator in the wheel radial direction to be adhered on the wheel.

3. The vehicle wheel according to claim 2, wherein
a gap is formed between the Helmholtz resonator and the stopper.

4. The vehicle wheel according to claim 1, wherein
the stopper integral with the Helmholtz resonator forms an annular body that extends in a wheel circumferential direction on an outer circumferential surface of a well part.
